(19) United States
(12) Patent Application Publication
(10) Pub. No.: US 2020/0023333 A1
(43) Pub. Date: Jan. 23, 2020

(54) Modification of a Solid Surface

(71) Applicant: Micronit Microfluidics B.V., Enschede (NL)

(72) Inventors: Rui Pedro Rijo da Costa Carvalho, Wageningen (NL); Sidharam Pundlik Pujari, Wageningen (NL); Elwin Xander Vrouwe, Enschede (NL); Johannes Teunis Zuilhof, Bennekom (NL)

(21) Appl. No.: 16/495,740

(22) PCT Filed: Mar. 22, 2018
(86) PCT No.: PCT/NL2018/050179

§ 371 Date: Sep. 19, 2019

(30) Foreign Application Priority Data
Mar. 22, 2017 (NL) 2018559

(51) Int. Cl. B01J 19/00

(52) U.S. Cl. CPC B01J 19/0046; B01J 2219/00837; B01J 2219/00835; B01J 2219/00632

(57) ABSTRACT

A process for the modification of a surface of a solid material, said solid material comprising a polymer material arranged at the surface of the solid material. Said process comprises the step of: contacting the polymer at the surface of the solid material with an oxygen source and a catalytic amount of a transition metal compound under such conditions that oxygen is incorporated into the polymer surface, wherein a hydroxy group is formed, which is attached to a carbon atom of the polymer.

### FIELD OF THE INVENTION

The invention relates to a process for modifying a surface of a solid material, said solid material comprising a polymer material arranged at the surface of the solid material, such as an internal surface of a microchannel of a microfluidic chip, and a solid material obtainable using this process.

### BACKGROUND

The ability to modify the surface of a solid material such as glass has facilitated many biomedical and chemical applications.

Known methods of modifying planar surfaces such as glass surfaces include a wide range of non-contact methods such as inkjet printing, photolithography, and plasma deposition.

These non-contact modification methods do not, however, work so well on non-planar surfaces. For example, the inside of a microchannel is far less amenable to these patterning methods. Therefore, the modification of the inside surface of microchannels has used soft lithography methods such as microcontact printing. However, as these soft lithography methods can only be used on exposed channel surfaces before sealing, the properties of the modified surfaces need to be compatible with any subsequent sealing process, for example, high-temperature fusion bonding of glass onto glass.

Moreover, a desire exists to use other materials than glass as a solid material in the same technical field of a microchannel of a microfluidic chip. For example, a solid polymeric material, such as a cyclic olefin (co)polymer, may be usable to provide a microfluidic chip having a number of microchannels. Cyclic olefin (co)polymers are an increasingly popular substrate due to their optical transparency, chemical resistance, low water absorption properties and good biocompatibility. However, a cyclic olefin (co)polymers is quite inert towards chemical modification, which hinders the ability to covalently functionalize the surface.

In order to effectively use the polymeric material as a solid material for biomedical and chemical applications, the surface of the solid polymer needs to be modifiable, when the polymer is in the solid state, depending on the desired surface properties needed for the biomedical and chemical application.

In order to be able to covalently modify a cyclic olefin polymer substrate (e.g. by silanization), the surface first needs to be activated. Activation of a cyclic olefin polymer surface into a nucleophilic anchor-containing surface can be achieved via oxidation of the alkane surface into C—OH groups (e.g alcohol or acid). A typical oxidation method makes use of oxygen or air plasma to convert the C—H terminus into a C—Ox (e.g. alcohol, acid, ketone, aldehyde).

An air plasma-based treatment of the cyclic olefin polymer substrates for a short time, such as 10 s, gives immediate results. The static contact angle with water drops from 100° to less than 30°, indicating the formation of a variety of hydrophilic surface groups. When analysing the surfaces, e.g. by using GATR-FTIR, it becomes clear that a variety of surficial carbonyl species are present (see FIG. 2a). Analysis by XPS shows an increase in total oxygen content, while on C1s narrow scans there is a clear indication that multiple functional groups are now present on the surface (due to the increased full width half maximum of the main peak at 285.0 eV). Unfortunately, this surface-modification technique is not able to homogeneously functionalize the inside of intricate cyclic olefin polymer channels due to plasma-diffusion limitations.

The present invention is, therefore, directed towards an improved method for modifying the surface of a solid material, said solid material comprising a polymer material arranged at the surface of the solid material. This improved method may at least partially avoid one or more of the disadvantages mentioned above. Preferably, the method of the present invention can be used on both planar and non-planar surfaces.

### SUMMARY OF THE INVENTION

In a first aspect, the present invention relates to a process for the modification of a surface of a solid material, said solid material comprising a polymer material arranged at the surface of the solid material, said process comprising the step of: i. contacting the polymer at the surface of the solid material with an oxygen source and a catalytic amount of a transition metal compound under such conditions that oxygen is incorporated into the polymer surface, wherein a hydroxy group is formed, which is attached to a carbon atom of the polymer.

This first aspect of the invention is a novel process for modifying a polymer surface of a solid material. This process makes it possible to reliably and mildly oxidise the polymer surface of the solid material. Due to the oxidation process a hydroxy group is formed by oxidizing a carbon atom of the polymer. The transition metal compound catalyses the oxidation of the carbon atom of the polymer by the oxygen source. As a result of the catalysed oxidation, a mild and controlled oxidation of the surface of the polymer may be obtained at room temperature, which is less destructive to the polymer compared to the plasma-treatment.

This mild oxidation is indicated by an increased amount of hydroxyl groups at the surface of the polymer in combination with a reduced amount of carbonyl groups at the surface of the polymer or a reduced amount of other types of oxidised carbon groups, when compared to the oxidised surface obtained by a plasma-treatment.

This method can be applied to open plastic substrates as well as to bonded or internal microchannels, and may yield highly defined alcohol-terminated polymer surfaces with less or none carbonyl-containing moieties. Due to their nucleophilic character, such surface-bound alcohol moieties can be used for a very wide array of surface modifications. This process provides a more controlled and uniform oxidation process compared to the plasma-based treatment, which can not sufficiently and controllably reach an internal surface of a solid material, such as a surface of an internal microchannel of a micro fabricated structure.

In a preferred exemplary embodiment, during the modification step i. the oxygen is predominantly incorporated in the polymer surface in the form of the hydroxy group, which is attached to a carbon atom of the polymer, with respect to all carbon-oxygen bonds formed at the polymer surface. In this embodiment, more than 50% of the oxygen is incorporated in the polymer surface in the form of the hydroxy group, with respect to all carbon-oxygen bonds formed at the polymer surface.

The carbon atom of the polymer, to which the hydroxy group is bonded, may be after the oxidation a saturated carbon atom, i.e. which carbon atom is covalently bonded to at least one other carbon atom of the polymer as a C—C bond.

In exemplary embodiments, the carbon atoms may be present in the polymer before oxidation as a R¹—CHR²—R³ group, a R¹—CH₂—R³ group or a R¹—CH₃ group or combinations thereof. The hydrogen atom, which is attached to a saturated carbon atom is replaced by a hydroxyl group due to the oxidation step. Herein, R¹, R², and R³ are substituents, which can be the same or different to one another.

Additionally or alternatively, in other exemplary embodiments the carbon atom may be present in the polymer before oxidation as a R¹—C═CH—R² group, as a R¹—C═CH₂ group or as a R¹—C≡CH group or combinations thereof. The hydrogen atom, which is attached to the unsaturated carbon atom is replaced by a hydroxyl group due to the oxidation step. The unsaturated carbon may in embodiments be transformed in a saturated carbon atom due to the oxidation step (having single covalent bonds to adjacent carbon atoms only). Herein, R¹ and R² are substituents, which can be the same or different to one another.

The solid material modified in this process is defined as a material that is in the solid state whilst the process is being carried out. For example, if the process is conducted at room temperature, the solid material is a material that is in the solid state at room temperature.

In an exemplary embodiment, during the modification step i. the oxygen source and the transition metal compound are applied onto the polymer at the surface of the solid material as a solution thereof in a solvent. Preferably, the solvent may be an aqueous solvent, i.e. a solvent comprising water, thereby forming an aqueous solution of the oxygen source and/or of the transition metal compound.

In an exemplary embodiment, the oxygen source may comprise a peroxide, such as a hydrogen peroxide. Said peroxide is a relatively strong oxidizer, which is readily available. The oxidation process using the peroxide can be catalysed using the transition metal compound. Without the transition metal compound substantially no oxidation of the surface of the polymer material occurs. In an exemplary embodiment, said peroxide may be provided as an aqueous solution thereof.

In exemplary embodiments, the transition metal compound comprises at least one cation selected from the group consisting of Chromium, Manganese, Iron, Cobalt, Nickel and Copper. Said transition metal compound may be used in a catalytic amount for catalysing the oxidation process of the polymer.

In a preferred embodiment, the cation comprises a Cu(II) cation. The Cu(II) cation has shown to enable the catalysing reaction of catalysing the oxidation process of the polymer.

Additionally or alternatively, in exemplary embodiments, the transition metal compound comprises at least one cation selected from the group consisting of Rhodium, Palladium, and Platinum.

In exemplary embodiments, the transition metal compound comprises Cu(II) (acetate)2 or Cu(II) (nitrate)2. The copper acetate and the copper nitrate are soluble in an aqueous liquid, such as demineralised water, to form an aqueous solution. The copper acetate and/or copper nitrate may easily he combined with a peroxide in the aqueous solution. The transition metal compound may be used in the aqueous solution for modifying the surface without leaving traces or residues of the transition metal compound on the surface of the polymer.

In an exemplary embodiment, during the first modification step i. the concentration of the transition metal compound in a solvent is less than 100 mM. As the transition metal compound catalyses the oxidation step, only a relatively low concentration of transition metal compound in the solvent, such as an aqueous solvent, is needed. The transition metal compound catalyses the oxidation step at room temperature.

In an exemplary embodiment, the first modification step i. is assisted by applying a microwave irradiation to the solid material.

In an exemplary embodiment, the first modification step i. is performed at temperatures below a phase transition temperature of the polymer, such as a glass transition temperature Tg or a melting transition temperature Tm of the polymer.

In an exemplary embodiment, said surface is an internal surface of the solid material, preferably said surface is a surface of a micro fabricated structure inside the solid material. In an example, the micro fabricated structure inside the solid material may be a microchannel of the solid material. The oxidation process may be carried out by flushing a microchannel of the solid material, e.g. by using a peroxidative solution according to the present invention. The reactants, i.e. the oxygen source, such as hydrogen peroxide, and the transition metal compound may be provided as an aqueous solution thereof, wherein the reactants may easily be washed from the microchannel of the solid material after the oxidation process.

In an exemplary embodiment, the oxygen source, such as peroxide, and the transition metal compound, such as copper acetate or copper nitrate, are applied in the form of an aqueous solution thereof. The advantage of an aqueous solution is that the surface of the polymer is substantially not disturbed or contaminated by the aqueous solvent, as the polymer does substantially not absorb the aqueous solvent.

In an exemplary embodiment, the modification step i. comprises using a patterned stamp structure for locally contacting the surface of the polymer, thereby locally bringing the oxygen source and/or the transition metal compound in contact with the surface of the polymer.

In an exemplary embodiment, the stamp structure comprises a gelled material, such as a hydrogel material, having the transition metal compound arranged at its contacting surface.

In an exemplary embodiment, the stamp structure comprises an elastic material, such as polydimethylsiloxane (pdms), configured for carrying the oxygen source and/or the transition metal compound, preferably in the form of an aqueous solution, at its contacting surface.

In an exemplary embodiment, the first modification step i. is assisted by adding an acidic component in a substantially catalytic amount. An acidic component is a proton donating component. An aqueous solution of the acidic component has an pH being acidic (i.e. the pH of an aqueous solution of the acidic component is lower than pH 7). For example, a nitric acid in a substantially catalytic amount, such as less than 100 mM, may be used to increase the yield of obtaining the hydroxy group, which is attached to a carbon atom of the polymer, with respect to all carbon-oxygen bonds formed at the polymer surface. In this embodiment, more than 50% of the oxygen is incorporated in the polymer surface in the form of the hydroxy group, with respect to all carbon-oxygen bonds formed at the polymer surface.

In an exemplary embodiment, said process comprising the step of: ii. Contacting the oxidized polymer surface obtained in the oxidation step i. with a reducing agent to obtain a polymer surface having hydroxy nucleophilic groups, which are attached to carbon atoms of the polymer.

By applying the reducing agent to the oxidized polymer surface, the amount of hydroxy nucleophilic groups on the surface is increased. Any oxidized carbon, such as a carbonyl group C═O, may be reduced to —C—OH group by the reducing step.

The increase of the amount of hydroxy nucleophilic groups on the surface may be indicated by a (further) reduction of the water static contact angle.

In an exemplary embodiment, the reducing agent comprises a borohydride, preferably a sodium borohydride. The borohydride may be applied being dissolved in methanol or any other suitable solvent. Sodiumborohydride is a suitable reducing agent for converting the oxidized group on the surface of the polymer to a —C—OH group.

In an exemplary embodiment, the polymer comprises a cyclic olefin polymer, preferably a cyclic olefin copolymer. Cyclic olefin copolymers are produced by chain copolymerization of cyclic monomers such as 8,9,10-trinorborn-2-ene (norbornene) or 1,2,3,4,4a,5,8,8a-octahydro-1,4:5,8-dimethanonaphthalene (tetracyclododecene) with ethene (such as TOPAS Advanced Polymer's TOPAS, Mitsui Chemical's APEL), or by ring-opening metathesis polymerization of various cyclic monomers followed by hydrogenation (Japan Synthetic Rubber's ARTON, Zeon Chemical's Zeonex and Zeonor). These later materials using a single type of monomer are more properly named cyclic olefin polymers.

Cyclic olefin copolymers comprise one of the new classes of polymers based on cyclic olefin monomers and ethene monomer. Cyclic Olefin Copolymer (COC) is an amorphous polymer made by several polymer manufacturers. COC is a relatively new class of polymers as compared to commodities such as polypropylene and polyethylene. This newer material is used in a wide variety of applications including packaging films, lenses, vials, displays, and medical devices. Typical COC material will have a higher modulus than HDPE and PP, similar to PET or PC. COC also has a high moisture barrier for a clear polymer along with a low moisture absorption rate. In medical and analytical applications, COC is noted to be a high purity product with low extractable. COC is also a halogen-free and BPA-free product.

In an exemplary embodiment, the cyclic olefin polymer comprises an ethylene polymer segment and/or a norbornene polymer segment. The ethylene polymer segment and/or the norbornene polymer segment can easily be oxidized by the process according to the present invention.

In an exemplary embodiment, the polymer comprises at least one segment of the group consisting of a polyolefin segment, a polymethylmethacrylate segment, a polystyrene segment and a polycarbonate segment. Any of these polymers have a carbon group, being present in the polymer as a R¹—CHR²—R³ group, a R¹—CH2—R³ group or a R¹—CH3 group or combinations thereof, which can be oxidized by the process according to the present invention. In an example, each polycarbonate segment has two R—CH3 groups.

In an exemplary embodiment, the polymer comprises a polyphenyl ether segment and/or a polyether ether ketone segment. When these polymers are substituted, they may comprise a carbon group, being present in the polymer as a R¹—CHR²—R³ group, a R¹—CH2—R³ group or a R¹CH3 group or combinations thereof, which can be oxidized by the process according to the present invention.

Additionally or alternatively, when these polymers are substituted, they may comprise a carbon group, being present in the polymer as a R¹—C═CH—R² group, as a R¹—C═CH₂ group or as a R¹—C≡CH group or combinations thereof, which can be oxidized by the process according to the present invention.

In an exemplary embodiment, the process further comprises the steps of: iii. contacting the surface of the solid material comprising the polymer including hydroxy nucleophilic groups attached thereon with a hydrosilane to produce a hydrosilanized surface, and iv. contacting said hydrosilanized surface with at least one alkene and/or alkyne and/or an alcohol under irradiation with visible and/or ultraviolet light.

Any hydrosilane that can react with nucleophilic groups on the surface of the solid material to produce a hydrogen-terminated layer on this surface is suitable for use in the first aspect of the invention. In embodiments of this process, the hydrosilane may have the following formula:

H—Si—X(R¹)(R²).

wherein X is a hydrolysable group such as an alkoxy, acyloxy, halogen or amine group.

R¹ and R² can be the same as, or different to, the hydrolysable group X. If R¹ and R² are both the same as X, the formula can be simplified to: H—Si—X₃

As in the example above, the R¹ and R² groups may be the same. Alternatively, the two substituents may be different. For example, in one embodiment R¹ may be the same a group X and R² may be different. In such embodiments, the general formula of the hydrosilane would be: H—Si—X₂(R)

The R group substituent (including R¹ and R²) may be an organic or organometallic moiety or an inorganic atom or group.

In some embodiments, the R group may provide radical stability during the silanization step of the process of the invention (i.e. during the Si—H dissociation). In embodiments in which the R substituent provides radical stability, this may enable the second step of the process to be carried out under irradiation at longer wavelengths. R groups that may provide such radical stability include vinyl and phenyl groups.

Alternatively, the R substituent may provide an additional functionality with a reactivity orthogonal to the Si—H bond, thereby yielding two independent modes of functionalisation. In some embodiments, the R group may provide this additional functionality in addition to radical stability. R groups that may provide such features include azide groups.

In some embodiments, the hydrolysable X group may be a chloro or alkoxy group, i.e. X may be Cl or OCₙH₂ₙ₊₁.

If the hydrosilane is an alkoxysilane, this alkoxysilane may have the general formula H—Si(OCₙH₂ₙ₊₁)₃₋ₓRₓ, where x=0, 1 or 2.

If the hydrosilane is a chlorosilane, this chlorosilane may have the general formula H—SiCl₃₋ₓRₓ, where x=0, 1 or 2.

In these general formulas for an alkoxysilane and a chlorosilane, the R group may be an organic, organometallic or inorganic moiety.

Any chloro or alkoxy silane that can react with nucleophilic groups present on the surface of the solid material to produce a hydrogen-terminated layer on this surface is suitable for use in the first aspect of the invention. Suitable hydrosilanes for use in the first step of the process include, but are not limited to, triethoxysilane (H—Si(OC₂H₅)₃), trimethoxysilane (H—Si(OCH₃)₃) and trichlorosilane (H—SiCl₃).

In a subsequent step of the process, a light-induced reaction between the silanized surface and one or more alkenes or alkynes or alcohol compounds takes place.

Considering that light in the presence of water can be used to hydrolyse the Si—H surface, one could also use light in the presence of a molecule of formula R—OH (such as water H—OH, an alcohol C—OH, or a silica-hydroxide molecule Si—OH) to locally modify a COC—O—Si—H group.

The exact wavelength of the visible or ultraviolet light most suitable for use in the process depends upon the particular silane and alkene/alkyne/alcohol used in the reaction. For example, if the silane has a substituent which can provide radical stability, Si—H dissociation may be achieved more readily.

In some embodiments of the process, the silanized surface may be contacted with at least one alkene/alkyne and/or an alcohol under irradiation with light with a wavelength between 200 nm and 700 nm, for example, between 254 nm and 700 nm.

In some embodiments of the process, the silanized surface is contacted with at least one alkene or alkyne under irradiation with ultraviolet light in the second step. In such embodiments, the ultraviolet (UV) light may have a wavelength between 254 nm and 400 nm. Preferably, the UV light used in the second step of the process has a wavelength between 285 nm and 400 nm, for example, between 300 nm and 400 nm.

Preferably, the process uses UV light with a wavelength of between 285 nm and 365 nm. More preferably, the wavelength of UV light used in the process is between 300 nm and 364 nm, for example, between 300 nm and 355 nm. In some embodiments, the wavelength has a wavelength between 302 nm and 330 nm. In some embodiments, the UV light may have a wavelength of 302 nm.

Additionally, the present invention may provide a process for the patterning of the solid material. In such methods, the process comprises exposing the silanized surface to visible or UV light through a mask, for example, a photomask, in the light-induced step of the process. Such a photolithographic method enables the modification of controlled areas of the surface of the solid material.

If the process is used to modify an internal surface of a structure by applying the visible and/or UV light to the external surface of the structure, the solid material forming the structure must be at least partially transparent to the wavelength of the light used in the photochemical process.

The alkene or alkyne used in the process may be any alkene or alkyne capable of reacting with the silane deposited onto the surface of the solid material.

Preferably, the alkene/alkyne is terminal alkene/alkyne, i.e. and alkene/alkyne molecule with the alkene-alkyne functional group located at the end of the molecule. For example, the silanized surface can be contacted with any alkene or alkyne comprising between 2 and 50 carbon atoms. Specific examples of suitable terminal alkenes and alkynes include 1-hexadecene, 10-aminodec-1-ene or 1-hexadecyne.

In an exemplary embodiment, the present invention relates to a microfluidic chip, wherein the microfluidic chip comprises at least one microchannel, and wherein an internal surface of the microchannel is provided by a polymer material, wherein oxygen is incorporated into the polymer surface, wherein hydroxy groups are present, which are attached to a carbon atom of the polymer, which hydroxy groups are obtainable by the method according to the present invention.

The internal surface of the microchannel comprises a polymer material according to exemplary embodiments of the present invention. In a preferred exemplary embodiment, the microfluidic chip is mainly constituted by the polymeric material. This provides a simple design, wherein the polymeric material provides the basic structure of the microfluidic chip.

In an exemplary embodiment of the method the surface of the polymer material in the microchannel is at least partially covered by a layer, which layer is obtainable by bonding a hydrosilane to the internal surface of the microchannel according to the method of the present invention, and reacting the hydrosilane with at least one alkene or alkyne under irradiation with light.

In embodiments of the microfluidic chip, the layer may be a monolayer.

In the exemplary embodiment, the internal surface of the microchannel is preferably modified by applying the UV light to an external surface of the structure. Therefore, in such embodiments, the microfluidic chip must be at least partially transparent to the ultraviolet or visible light in one or more areas surrounding the microchannel(s).

### DESCRIPTION OF THE FIGURES

FIG. 1A shows a reaction scheme for the modification of COC (i) into a nucleophilic surface, COC—OH, via copper-catalyzed peroxidative oxidation.

FIG. 1B shows a reaction scheme for the modification of COC (i) into a nucleophilic surface, COC—OH, via copper-catalyzed peroxidative oxidation, which is followed by a mild reductive washing step.

FIG. 1C shows a reaction scheme for the subsequent silanization with HSiCl₃/HSiPhCl₂ (5:1), which yields the COC—Si-Φ₁-H₅ hybrid material.

FIG. 1D shows a reaction scheme for the mild light-induced hydrosilylation with a terminal alkene.

FIG. 2 shows GATR-FTIR of a COC surface after oxidation by (a) air plasma for 10 s; (b) copper-catalyzed peroxidative oxidation for 30 min and (c) coppercatalyzed peroxidative oxidation with HNO₃ as additive for 30 min; (d) after washing with methanolic NaBH₄ (unmodified COC used as a reference background).

FIG. 3 shows XPS wide scans (i), C1s (ii) and O1s (iii) narrow scans of (a) COC subjected to air plasma; (b) COC oxidized with Cu(II)/H₂O₂ mixture for 30 minutes 5 W microwave irradiation at 40° C.; (c) COC oxidized with Cu(II)/H₂O₂ mixture at R.T. under sonification; (d) COC oxidized with Cu(II)/H₂O₂/HNO₃ mixture, and (e) COC oxidized with Cu(II)/H₂O₂ mixture and washed with methanolic NaBH₄; and (f) bare COC.

FIG. 4 shows (a) XPS wide scan of (b) a COC—Si-Φ₁-H₅ substrate. (c) GATR-FTIR of the COC—Si-Φ₁-H₅ substrates, showing the two Si—H stretching vibrations (COC—OH was used as reference background).

FIG. 5 shows (a) XPS wide scan of (b) a COC—Si-Φ₁-H₅ substrate modified with TFAAD in the presence of 330 nm light for 16 h. (c) GATR-FTIR of the TFAAD modified substrates, showing inversion of the two types of Si—H stretching vibrations and presence of the carbonyl from TFAAD.

FIG. 6 shows (a) Photograph and SEM image (b) of a TFAAD-patterned COC—Si-Φ₁-H₅ after exposure to DCM (dichloromethane) (30 min).

FIG. 7 shows a Microscope image of plastic microchip with (a) a TFAAD-modified COC channel; (b) a partially TFAAD-modified COC channel (the part on the left was coated; the right part is uncoated) after exposure to a flow of DCM (white arrow indicates flow direction; 50 μL/min; 30 min), showing significantly more damage in the uncoated part.

FIG. 8 shows a reaction scheme for the light-induced reaction of an R—OH compound with a silanized COC-substrate.

### DETAILED DESCRIPTION OF THE INVENTION

### Static Water Contact Angle Measurements (SCA):

Static water contact angles (SCA) were measured using a Krüss DSA-100 goniometer. Droplets of 3 μL were dispensed on the surface, and contact angles measured with a CCD camera using a tangential method. The reported value is the average of at least five droplets of at least three different samples, and has an error of ±1° between samples.

### Germanium Attenuated Total Reflection Fourier Transform Infrared Spectroscopy (GATR-FTIR):

GATR-FTIR spectra were recorded with a Bruker Tensor 27 FT-IR spectrometer, using a commercial variable-angle reflection unit (Auto Seagull, Harrick Scientific). A Harrick grid polarizer was installed in front of the detector and was used for measuring spectra with p-polarized radiation with respect to the plane of incidence at the sample surface. Single channel transmittance spectra were collected at an angle of 25° using a spectral resolution of 2 cm⁻¹ and 2048 scans while flushing with dry N₂. Obtained spectra were referenced with a clean H-glass substrate (H-glass substrates were referenced with freshly plasma-cleaned glass).

### X-Ray Photoelectron Spectroscopy (XPS):

XPS spectra were recorded on a JPS-9200 photoelectron spectrometer (JEOL, Japan). The analysis was performed under ultra-high vacuum conditions using a monochromatic Al Kα source at 12 kV and 20 mA and an analyzer pass energy of 10 eV. A takeoff angle ϕ of 80° was used, with a precision of ±1°. All XPS spectra were analyzed with Casa XPS software (version 2.3.15). The binding energies were calibrated on the hydrocarbon (CH₂) peak with a binding energy of 285.0 eV. Because of the electrostatic charging of the surface during the measurements, a charge compensation was used with an accelerating voltage of 2.8 eV and a filament current of 4.80 A.

### Atomic Force Microscopy (AFM):

AFM images (512×512 pixels) were obtained with an MFP3D AFM (Asylum Research, Santa Barbara, Calif.). The imaging was performed in contact mode under air using NP silicon nitride cantilevers with a stiffness of 0.58 N/m (Veeco Metrology, Santa Barbara, Calif.) at a scan speed of 1 μm/s. Images were flattened with a zeroth-order flattening procedure using MFP3D software.

### Scanning Electron Microscopy/Scanning Auger Microscopy (SEM/SAM):

Morphologies of TFAAD micropatterns were analyzed by SEM/SAM. Measurements were performed at room temperature with a scanning Auger electron spectroscope system (JEOL Ltd. JAMP-9500F field emission scanning Auger microprobe). SEM and SAM images were acquired with a primary beam of 0.8 keV. The takeoff angle of the instrument was 0°. For Auger elemental image analysis an 8 nm probe diameter was used.

### EXAMPLES

### Materials and Chemicals

1-Hexadecene was obtained from Sigma Aldrich and distilled twice before use. Acetone (Aldrich, semiconductor grade VLSI PUNARAL Honeywell 17617), dichloromethane (DCM, Sigma Aldrich) and n-hexane (Merck Millipore) were used for cleaning before modification and Milli-Q water (resistivity 18.3 MΩ×cm) for rinsing after hydrolysis process. Cyclic olefin copolymer (COC, grade 6013) was obtained from TOPAS Advanced Polymers. All other chemicals were purchased from Sigma Aldrich and used as received. 10-Trifluoro-acetamide-1-decene (TFAAD) was synthesized based on literature methods.²⁰

### Substrate Preparation

### Plasma-Activated Cyclic Olefin Co Polymer (COC):

The COC substrate obtained from TOPAS was sonicated in isopropanol (iPrOH) for 30 min, rinsed with iPrOH after taking it out, and dried under a stream of nitrogen.

### Oxidation

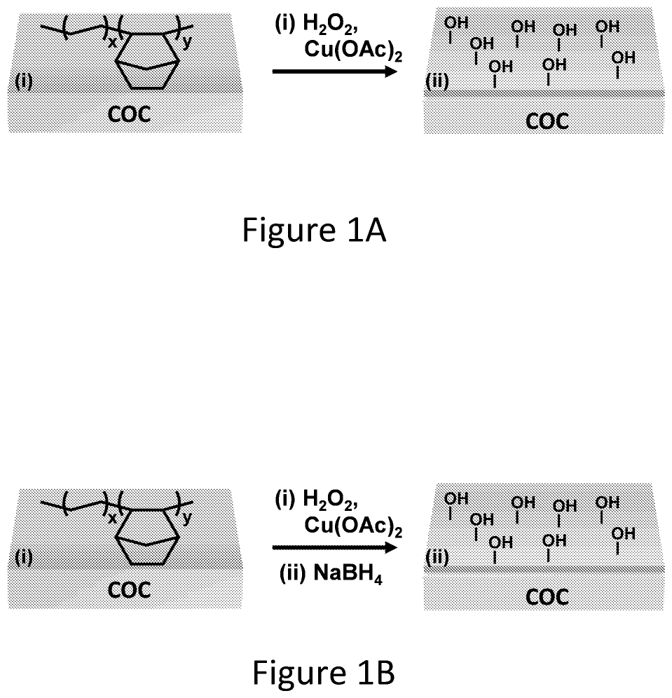

In order to be able to covalently silanize a COC substrate, the surface first needs to be activated. Activation of a COC surface into a nucleophilic anchor-containing surface can be achieved via oxidation of the alkane surface into C—OH groups (e.g. alcohol or acid). A ubiquitous surface oxidation method makes use of oxygen or air plasma, modifying the C—H terminus into a C—Ox (e.g. alcohol, acid, ketone, aldehyde). This plasma method was evaluated and compared with a mild oxidation based on exposure to an aqueous solution of hydrogen peroxide and a copper acetate (FIG. 1A). FIG. 1A shows a reaction scheme for the modification of COC (i) into a nucleophilic surface, COC—OH, via copper-catalyzed peroxidative oxidation, which may optionally in an exemplary embodiment be followed by a mild reductive washing step.

### Using Plasma Treatment of COC Substrates

An air plasma-based treatment of COC substrates for 10 s gives immediate results. The static water contact angle drops from 100° to <30°, indicating the rapid formation of hydrophilic surface groups.

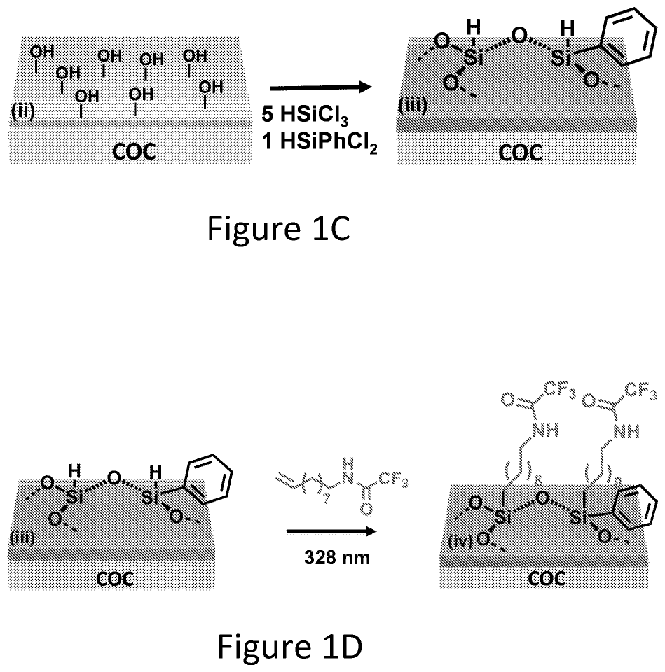

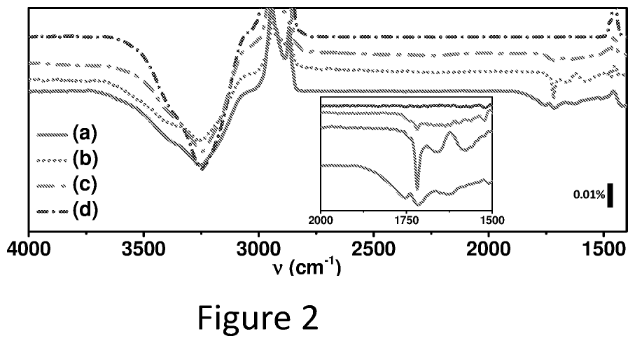

From GATR-FTIR measurements it becomes clear that a variety of surficial carbonyl species are present (FIG. 2a). FIG. 2a shows GATR-FTIR of a COC surface after oxidation by air plasma for 10 s. Wide range XPS data reveal an increase in total oxygen content (FIG. 3a), while XPS C1s narrow scans show many peaks to indicate that multiple functional groups are now present on the surface (due the presence of various oxidized forms of carbon, e.g. (C—OH) 286.9 and 289.3 (C═O). Unfortunately, this surface modification technique is not able to homogeneously functionalize the inside of intricate COC channels due to plasma-diffusion limitations in microfluidic devices.

### Using Catalysed Peroxidation of COC Substrates

In order to bypass the limitations stated above, we first exposed COC to 30% (v/v) H₂O₂ and no change in the water contact angle was observed, even after simultaneous sonication for 30 mins.

Then it was compared with a mild oxidation based on exposure to an aqueous solution of hydrogen peroxide—20% (v/v)—and copper acetate (20 mM) (FIG. 1A). Upon the addition of copper(II) acetate, a contact angle of 83±2° was obtained in just 30 min by contacting the aqueous solution of hydrogen peroxide—20% (v/v)—and copper acetate (20 mM) to the surface of the COC substrate at room temperature using sonication.

We reviewed how the addition of additives, such as triphenylphosphine PPh₃, in the washing/quenching solution can be used after the oxidation step to favour the decomposition of the CyOO· species into the alcohol (CyOH) counterparts instead of into ketones or other minor overoxidation products such as esters.

However, attempts to use PPh₃ to favor the conversion of COC—OO· to COC—OH did not yield satisfactory results. The PPh₃ oxidation adduct (O═PPh₃) forms a sticky precipitate that whitens the substrates and clogs microfluidic channels.

Adding a small amount of nitric acid (20 mM) in the oxidation solution, increased the yield slightly and shows some tuning ability towards the alcohol product is possible; similar results were found in solution.

Additionally, after the oxidation step a washing step with a polar solvent, such as methanol, may be used to remove Cu oxide contaminants from the surface of the polymer.

### Using Additional Reducing Step

We found an easy method for reducing the oxidized surface of the polymer by using methanolic NaBH₄ (40 mM) in the washing step (by sonication for 5 mins at room temperature) of the copper catalyzed oxidized surfaces (see reaction scheme in FIG. 1B). FIG. 1B shows a reaction scheme for the modification of COC (i) into a nucleophilic surface, COC—OH, via copper-catalyzed peroxidative oxidation, which is followed by a mild reductive washing step by using methanolic NaBH₄ in the washing step.

This yielded further a reduction in the water static contact angle to 72±2°. These values are close to those of other COC—OH substrates found in literature.

Our method represents a clear improvement in that it is much milder (no UV required, room temperature, aqueous solution), and leaves far less contaminants on the surface.

To further corroborate the exemplary embodiments of the process according to the present invention, the surfaces were analyzed by GATR-FTIR (FIG. 2b-d). FIG. 2 shows GATR-FTIR of a COC surface after oxidation by (a) air plasma for 10 s; (b) copper-catalyzed peroxidative oxidation for 30 min and (c) coppercatalyzed peroxidative oxidation with HNO₃ as additive for 30 min; (d) after washing with methanolic NaBH4 (unmodified COC used as a reference background).

The presence of alcohol (3174 cm−1) and carbonyl groups (1735 cm−1) indicates that the surface has undergone oxidation. The reduced amount of carbonyl-related stretching peaks compared to what is observed upon air plasma treatment is further evidence that the aqueous Cu/H₂O₂ oxidation is mild. Of specific interest is the basically flat IR spectrum in the C═O region (FIG. 2d) upon NaBH₄washing.

XPS wide scans show that our peroxidative treatment yields a clear increase of oxygen content when compared to bare COC, and less than for plasma-treated COC (FIG. 3a-e).

FIG. 3 shows XPS wide scans (i), C1s (ii) and O1s (iii) narrow scans of (a) COC subjected to air plasma; (b) COC oxidized with Cu(II)/H₂O₂ mixture for 30 minutes 5 W microwave irradiation at 40° C.; (c) COC oxidized with Cu(II)/H₂O₂ mixture at room temperature under sonication; (d) COC oxidized with Cu(II)/H₂O₂/HNO₃ mixture, and (e) COC oxidized with Cu(II)/H₂O₂ mixture and washed with methanolic NaBH₄; and (f) bare COC.

In FIG. 3 (ii) the C1s narrow scans indicate a predominance of C—C bonds (285.0 eV) for all substrates, while in the oxidized substrates C—OH and C═O are distinctively present (286.8 and 289.3 eV).

In FIG. 3 (iii, a), the O1s narrow scans show the presence of C—O—H (532.7 eV-57.6%) and O—C═O (533.8 eV-42.4%) for the COC that was subject to plasma treatment.

COC that has been subjected to the Cu/H₂O₂ oxidation (see FIG. 3c) or Cu/H₂O₂/HNO₃ oxidation (see FIG. 3d) show a predominant presence of C—O—H (532.4 eV-56% or 68%) along with the less prevalent C═O (531.4 eV-17.2% or 11.6%), O—C═O (534.0 eV-26.5% or 20.1%), and copper oxide (529.9 eV) contaminants due to just washing with water for analysis purposes.

### Microwave Radiation

Furthermore, COC that has been subjected to the Cu/H₂O₂ oxidation while being subjected to a microwave irradiation of 5 W (see FIG. 3b) for 30 minutes show a further increase of presence of C—O—H (532.4 eV) with respect to the Cu/H₂O₂ oxidation under sonication without using microwave (see FIG. 3c) along with a less prevalent C═O (531.4 eV), O—C═O (534.0 eV).

The amount of oxidation O1s has increased by subjecting the substrate to a microwave irradiation of 5 W during oxidation (9.5% with microwave irradiation versus 5.0%-7.6% without microwave irradiation). Furthermore, the selectivity towards C—O—H (532.4 eV) has increased due to the microwave irradiation.

Furthermore, in line with the IR and C1s XPS results, the inclusion of a subsequent washing step of reductive agent NaBH₄ (see FIG. 3e) yields a near-quantitative conversion to alcohols, free of Cu oxide contaminants.

The resulting presence of basically only one type of oxidized carbon, i.e. C—O—H (532.4 eV), is a major improvement over air/oxygen plasma methods.

As previously mentioned, the ability to generate OH terminated COC surfaces allows for a wide variety of functionalization chemistries. In the current paper, we present as an example the first of those under current development. Given the increasing use of COC in the fabrication of microfluidic devices, chemistries that allow for plastics photolithography are extremely desirable.

### Stamp Patterning Process

An another experiment, a patterned stamp structure is used for locally contacting the surface of the polymer, thereby locally bringing the a solution of the oxygen source and the transition metal compound in contact with the surface of the polymer.

The stamp structure comprises an elastic material, which in this example is polydimethylsiloxane (pdms). A hydrogen peroxide oxygen source H₂O₂ and the transition metal compound (Cu(II)acetate) in the form of an aqueous solution thereof are provided on a contacting surface of the pdms stamp by dipping the PDMS stamp in a Cu(II)acetate/H₂O₂ solution and press the contacting surface of the pdms stamp including the Cu(II)acetate/H₂O₂ solution onto half of a COC substrate.

After the experiment a considerably reduction is observed in contact angle of the processed (half part) surface of the COC substrate from 98-100° to 92°.

In this way, a controlled patterned part of the surface of the COC substrate may be processed according to exemplary embodiments of the process of the present invention, thereby oxidizing the surface of the COC polymer.

Additionally, further modifications of the controlled patterned parts on the surface of the COC substrate may be carried out according to exemplary embodiments of the process of the present invention.

### Silanization of the COC Polymer Surface

In line with our previous work done on borosilicate glass and described in co-pending application in The Netherlands with application number 2016290, which is hereby incorporated by reference, we aimed to modify COC—OH with a 5:1 mixture of trichlorosilane and dichlorophenylsilane.

With this, we envisioned to fabricate a hybrid material, hydrogen-(phenyl)-terminated silanized COC (COC—Si-Φ₁-H₅), that would have a similar reactivity as the previously reported H-Φ-glass.

Of specific interest were the findings that H-Φ-glass was shown to be highly stable in air for months, while smoothly reactive towards alkenes using light of ˜328 nm.

FIG. 1C shows a reaction scheme for the subsequent silanization with HSiCl3/HSiPhCl2 (5:1), which yields the COC—Si-Φ₁-H₅ hybrid material.

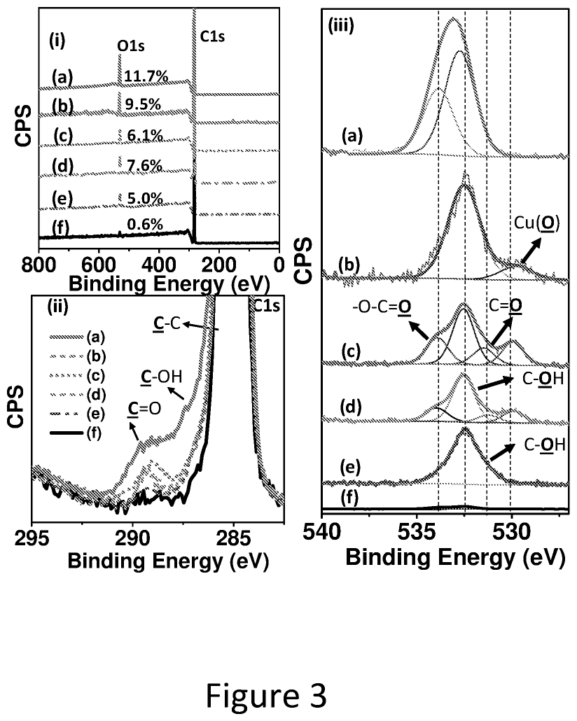

The hybrid material COC—Si-Φ₁-H₅ (FIG. 4B) was prepared along these lines and analyzed. Static water contact angles (85° for COC—Si—H and 90° for COC—Si-Φ₁-H₅) were similar to the ones we reported for analogous silicon-based substrates. XPS wide scans (FIG. 4A) show the presence of Si at 102 eV, indicating the formation of an ultrathin layer on top of COC.

Analysis by GATR-FTIR, while using COC—OH as a reference background, confirms the presence of two different Si—H stretching bands, which we attributed to O3Si—H at 2249 cm−1 and to O2ΦSi—H at 2185 cm−1 (FIG. 4C).

### Photochemical Surface Modification

Having characterized the COC—Si-Φ1-H5 substrates, we proceeded with modifying it further via light-induced hydrosilylation.

For this, we chose 10-trifluoro-acetamide-1-decene (TFAAD) as a reactivity probe. This alkene is useful to evaluate attachment, due to the IR-active carbonyl group and three C—F bonds with characteristic XPS C1s and F1s signals, and can be easily converted into an amine, upon deprotection.

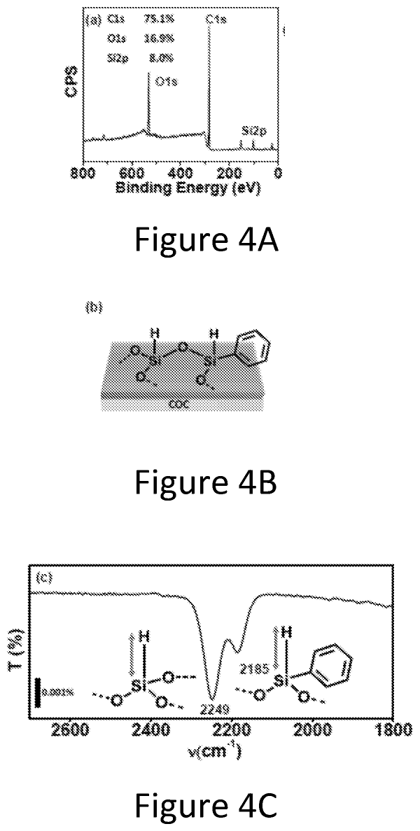

FIG. 1D shows a reaction scheme for the mild light-induced hydrosilylation with a terminal alkene. COC—Si-Φ₁-H₅substrates were modified with TFAAD using 328 nm light. The TFAAD-substituted COC—Si-Φ₁-H₅ substrates (as shown in FIG. 5B) were characterized by GATR-FTIR using COC—Si-Φ₁-H₅ as reference background.

The carbonyl stretching peak from TFAAD was clearly present at 1705 cm−1 (FIG. 5C). The reversal of the Si—H peaks at 2249 nm and 2185 nm indicates that there are less Si—H bonds than before the hydrosilylation, i.e., that the alkene reacted with the hydrogen-terminated surfaces forming Si—C bonds. Wide range XPS scans show the presence of fluorine, while C1s narrow scans indicate the presence of CF3 groups at 293.5 eV (FIG. 5A). This further confirms covalent attachment of TFAAD onto the COC—Si-Φ₁-H₅surfaces (as shown in FIG. 5B).

Similarly to the results obtained on glass, AFM measurements of these surfaces show that the roughness does not change considerably upon modification (RMS roughness from 1.9±0.2 nm to 2.0±0.5 nm), which is another significant improvement over plasma-based oxidations.

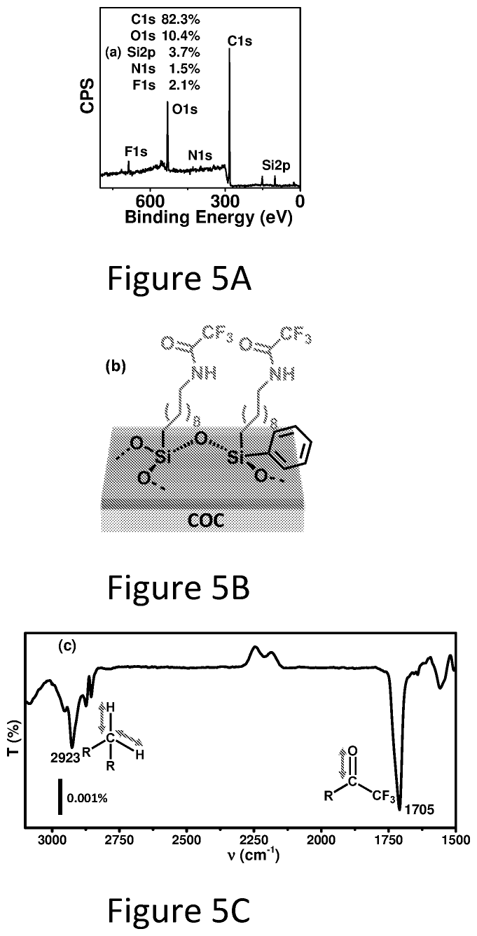

Photolithography on open substrates was performed by positioning a contact mask (circular TEM grid with circles and spokes) on top of the COC—Si-Φ₁-H₅ substrates during the light induced hydrosilylation reaction. We then planned to visualize the resulting pattern by scanning electron microscopy (SEM) (FIG. 6). FIG. 6 shows a Photograph (FIG. 6a) and SEM image (FIG. 6b) of a TFAAD-patterned COC—Si-Φ₁-H₅ after exposure to DCM (30 min).

Interestingly, when cleaning the modified substrate with dichloromethane (DCM) for 5 mins to allow for SEM measurements, we observed that the pattern had slowly become visible by naked eye (FIG. 6a). Further exposure to DCM showed clear degradation by the solvent of the non-exposed areas, while the TFAAD-modified areas resisted solvent damage effectively (FIG. 6b). Overall, the ability to covalently bind an ultrathin, yet highly protective coating that can be further modified, opens the use of these substrates for many applications.

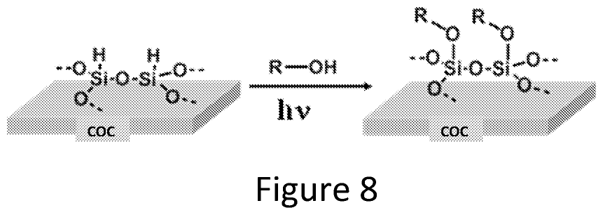

Alternatively, considering that light in the presence of water can be used to hydrolyse the Si—H surface, one could also use light in the presence of a molecule of formula R—OH (such as water H—OH, an alcohol C—OH. or a silica-hydroxide molecule Si—OH) to locally modify a COC—O—Si—H group. A reaction scheme for the light induced reaction with R—OH is illustrated in FIG. 8.

### Modification of Microfluid Device

We then finally proceeded to modify the channel of an already bonded COC microreactor (Micronit) into COC—OH by flowing the oxidation solution for 20 mins at 50 μL/min and washing for 5 mins (50 μL/min) with methanolic NaBH4.

Silanization was carried out and a fully modified COC—Si-Φ₁-H₅ microfluidic channel was photopatterned with TFAAD (see Info of photolithography for details).

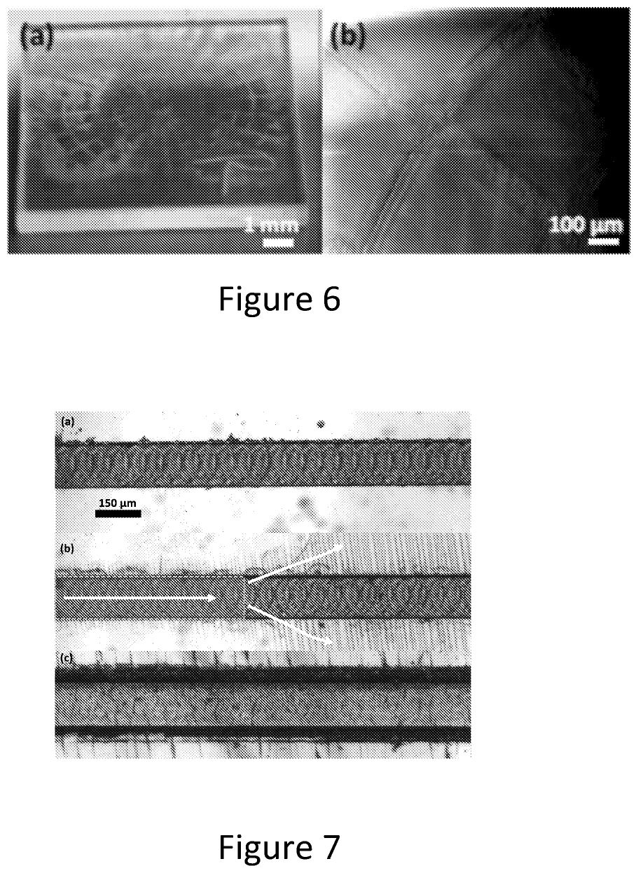

We then tested the ability of the TFAAD patches to protect the device from a prolonged flow of Dichloromethane DCM (30 min at 50 μL/min). As can be seen from FIG. 7b, the coating provides significant protection even to harsh solvents such as DCM.

In the absence of a protective coating, the polymer swells and cracks, starting as stripe-like cracks at the side of the channel (FIG. 7b). In addition, the bonding strength between the COC top and bottom substrates is severely weakened and leakage occurs. Since the TFAAD moiety is by no means optimized for this purpose, functional group optimization will likely provide significant possibilities for further improvement of the protection.

In conclusion, we have demonstrated a mild aqueous C—H activation method to modify the surface of cyclic olefin copolymers (COC).

This method can be applied to open plastic substrates as well as to bonded microchannels, and yields highly defined alcohol-terminated COC surfaces with less or none carbonyl-containing moieties. Due to their nucleophilic character, such surface-bound alcohol moieties can be used for a very wide array of surface modifications.

When e.g. reacted with hydrosilanes (such as Cl₃Si—H or Cl₂PhSi—H), this surface yields a hydrogen-terminated COC surface. This new hybrid surface is highly stable in air and photo-patternable via a mild light-induced hydrosilylation with terminal alkenes. The TFAAD functional monolayer attached in this fashion enhanced the resistance of the COC to organic solvents (e.g. DCM).

In addition, TFAAD is well known for its ability to undergo further surface modifications for e.g. biological applications.

This research opens a door towards the mild activation of what was considered a highly inert substrate that required harsh modification techniques. This technique is transposable to other C—H containing polymer analogues, e.g. a polymer comprises at least one segment of the group consisting of a polyolefin segment, a polymethylmethacrylate segment, a polystyrene segment and a polycarbonate segment, or polyphenyl ethers/oxides (PPEs/PPOs) and polyether ether ketone (PEEK) segment.

### Silanization

In the examples given, silanization may be performed using either triethoxysilane or trichlorosilane.

In the reactions with both triethoxysilane and trichlorosilane, O₃Si—H groups are formed onto the surface of the solid material. This bestows an entirely new chemical reactivity onto the solid material.

### Using Trichlorosilane (H—SiCl₃), COC and CVD:

Chemical vapour deposition (CVD) was used for gas-phase modification with H—SiCl₃. The COC substrate was held in a desiccator, and a H—SiCl₃ system prepared in the glove box was connected to this desiccator. The H—SiCl₃ flask was then used to fill the desiccator with trichlorosilane gas, and the silanization of the COC was carried out for 30 minutes. After 30 minutes, the system was then quenched.

### Photochemical Surface Modification

In example experiments carried out for the present invention, silanized substrates were subsequently used for the light-induced modification with an alkene or alkyne.

In this photochemical modification method, a drop of the chosen alkene or alkyne was placed on the flat silanized sample within a glove box. A slide, for example, a COC substrate, was then placed on the drop and gently pressed against the silanized sample to homogenously spread the alkene between the two slides, and also to mimic a closed microfluidic channel. The slide assembly was then illuminated with a UV pen lamp (with a wavelength of 254, 302, 330 or 365 nm, Jelight Company, Irvine, Calif., USA) which was placed approximately 4 mm above an external surface of either the silanized sample of the slide. The entire setup (i.e. the UV lamp and the slide assembly) was then covered in aluminium foil and the sample irradiated for 16 h. After irradiation, the substrates were extensively rinsed with distilled dichloromethane and hexane and dried under argon. The surfaces were then directly used for surface characterization or stored under air.

### Photolithography

### Planar Surface:

Photolithography was performed with a 302 nm lamp in combination with a gold electron microscope grid (SEM F1, Gilder Grids). This gold electron microscope grid (i.e. a photolithographic mask) was placed on top of a flat silanized sample of a solid material (for example, a slide of COC substrate) together with a drop of a suitable alkene. After the liquid had been spread across the silanized surface of the solid material, a borosilicate glass slide (SCHOTT) was placed on top of the mask as a cover, above which the UV pen lamp was placed at a distance of approximately 4 mm. The slide assembly was irradiated for 16 h. removed from the glove box and cleaned by extensively rinsing with distilled dichloromethane and hexane and drying under argon.

In this photolithography process, the gold electron microscope grid was used to pattern the surface by locally blocking UV light.

### Inside Surface of a Microchannel:

For the microchannels, photolithography was performed by applying a photolithographic mask on the bottom side of a microfluidic chip, for example, a chip provided by Micronit.

1. A process for the modification of a surface of a solid material, said solid material comprising a polymer material arranged at the surface of the solid material, said process comprising the step of:
i. contacting the polymer at the surface of the solid material with an oxygen source and a catalytic amount of a transition metal compound under such conditions that oxygen is incorporated into the polymer surface, wherein a hydroxy group is formed, which is attached to a carbon atom of the polymer.

2. The process according to claim 1, wherein during the modification step i. the oxygen is predominantly incorporated in the polymer surface in the form of the hydroxy group, which is attached to a carbon atom of the polymer, with respect to all carbon-oxygen bonds formed at the polymer surface.

3. The process according to claim 1, wherein the oxygen source comprises a peroxide material, preferably hydrogen peroxide.

4. The process according to claim 1, wherein the transition metal compound comprises at least one cation selected from the group consisting of Chromium, Manganese, Iron, Cobalt, Nickel and Copper, preferably a Cu(II) cation, or selected from the group consisting of Rhodium, Palladium, and Platinum.

5. The process according to claim 4, wherein the transition metal compound comprises Cu(II) (acetate)₂ or Cu(II) (nitrate)₂.

6. The process according to claim 1, wherein during the first modification step i. the concentration of the transition metal compound in a solvent is less than 100 mM.

7. The process according to claim 1, wherein the first modification step i. is assisted by applying a microwave irradiation to the solid material.

8. The process according to claim 1, wherein the first modification step i. is performed at temperatures below a phase transition temperature of the polymer, such as a glass transition temperature T_{g} or a melting transition temperature Tₘ of the polymer.

9. The process according to claim 1, wherein said surface is an internal surface of the solid material.

10. The process according to claim 9, wherein said surface is a surface of a micro fabricated structure inside the solid material.

11. The process according to claim 1, wherein the oxygen source and the transition metal compound are applied in the form of an aqueous solution thereof.

12. The process according to claim 1, wherein the modification step i. comprises using a patterned stamp structure for locally contacting the surface of the polymer, thereby locally bringing the oxygen source and/or the transition metal compound in contact with the surface of the polymer.

13. The process according to claim 12, wherein the stamp structure comprises a gelled material having the transition metal compound arranged at its contacting surface.

14. The process according to claim 12, wherein the stamp structure comprises an elastic material configured for carrying the oxygen source and/or the transition metal compound, preferably in the form of an aqueous solution, at its contacting surface.

15. The process according to claim 1, wherein the first modification step a) is assisted by adding an acidic component in a substantially catalytic amount.

16. The process according to claim 1, said process comprising the step of:
ii. contacting the oxidized polymer surface obtained in the oxidation step i. with a reducing agent to obtain a polymer surface having hydroxy nucleophilic groups, which are attached to carbon atoms of the polymer.

17. The process according to claim 1, wherein the reducing agent comprises a borohydride, preferably a sodium borohydride.

18. The process according to claim 1, wherein the polymer comprises a cyclic olefin polymer, preferably a cyclic olefin copolymer.

19. The process according to claim 18, wherein the cyclic olefin polymer comprises an ethylene polymer segment and/or a norbornene polymer segment.

20. The process according to claim 1, wherein the polymer comprises at least one segment of the group consisting of a polyolefin segment, a polymethylmethacrylate segment, a polystyrene segment and a polycarbonate segment.

21. The process according to claim 1, wherein the process further comprises the steps of:
iii. contacting the surface of the solid material comprising the polymer including hydroxy nucleophilic groups attached thereon with a hydrosilane to produce a hydrosilanized surface, and
iv. contacting said hydrosilanized surface with at least one alkene and/or alkyne under irradiation with visible and/or ultraviolet light.

22. A solid material, said solid material comprising a polymer material arranged at the surface of the solid material, wherein said surface is an internal surface of the solid material, said solid material being obtainable by the process according to claim 1.
